(19) United States
(12) Patent Application Publication
(10) Pub. No.: US 2014/0150204 A1
(43) Pub. Date: Jun. 5, 2014

(54) ASSEMBLY FOR MAINTAINING SEPARATION BETWEEN SPRING ASSEMBLY AND HINGE BRACKET THUS REDUCING INADVERTENT STRIKING

(71) Applicant: HONDA MOTOR CO., LTD., Tokyo (JP)

(72) Inventors: David Grummett, Innisfil (CA); Stephen Axt, Newmarket (CA); Jason Rogers, Newmarket (CA)

(73) Assignee: HONDA MOTOR CO., LTD., Tokyo (JP)

(21) Appl. No.: 13/689,849

(22) Filed: Nov. 30, 2012

(51) Int. Cl. E05D 11/00; E05F 1/10

(52) U.S. Cl. CPC E05D 11/00; E05F 1/1016
USPC 16/2.1; 16/308

(57) ABSTRACT

An apparatus comprising: a hinge bracket; a spring assembly configured to operatively interact with the hinge bracket; and a separation assembly being configured to permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

### TECHNICAL FIELD

Aspects generally relate to (and not limited to) a hinge bracket and a spring assembly, and more specifically, aspects relate to (and not limited to) a hinge bracket and a spring assembly arranged so as to reduce unwanted noise created as a result of inadvertent striking between the hinge bracket and the spring assembly.

### BACKGROUND

Noise, vibration, and harshness (NVH), also known as noise and vibration (N&V), is the study and modification of the noise and vibration characteristics of vehicles, particularly cars and trucks. While noise and vibration can be readily measured, harshness is a subjective quality, and is measured either via jury evaluations, or with analytical tools that provide results reflecting human subjective impressions. These latter tools belong to the field known as psychoacoustics. Interior NVH deals with noise and vibration experienced by the occupants of the cabin, while exterior NVH is largely concerned with the noise radiated by the vehicle (including drive-by noise testing). NVH is mostly engineering, but often objective measurements fail to predict or correlate well with the subjective impression experience by human observers. In some cases the NVH engineer is asked to change the sound quality, i.e. adding or subtracting particular harmonics, rather than making the car quieter. Wind and road noise transmitted through the car windows is a major source of a vehicle's interior noise. Increased cabin noise may affect not only the driver's experience, but may also increase driver fatigue.

### SUMMARY

The inventors have researched a problem associated with known hinges and springs especially of the type used in automobiles. After much study, the inventors believe they have arrived at an understanding of the problem and its solution, which are stated below.

The inventors faced a problem of reducing unwanted noise associated with a vehicle (such as a car and/or a truck). They developed a solution that improved acoustic control between a spring assembly and a hinge bracket of a vehicle. The solution may be deployed in non-vehicular applications as well (if so desired).

The inventors discovered that, from time to time, the spring assembly and the hinge bracket (of a trunk assembly of a vehicle) move relative to each other, and sometimes the spring assembly movement can be restricted by the hinge bracket. This results in stored spring energy which can suddenly be released, inadvertently causing occurrences of unwanted (undesirable) noise that reduce or degrade a user's experience and enjoyment of the vehicle or other systems that deploy the hinge bracket and the spring assembly.

In accordance with an aspect of our work, we (the inventors) have developed an apparatus comprising: a hinge bracket; a spring assembly configured to operatively interact with the hinge bracket; and a separation assembly being configured to permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

In accordance with another aspect of our work, we (the inventors) have developed an apparatus comprising: a separation assembly being configured to permit relative movement between a hinge bracket and a spring assembly configured to operatively interact with the hinge bracket without permitting the spring assembly and the hinge bracket from inadvertently striking against each other, whereby occurrence of unwanted noise associated with the spring assembly and the hinge bracket striking each other is reduced.

In accordance with another aspect of our work, we (the inventors) have developed an apparatus comprising: a trunk assembly (which may be called a door assembly or trunk-door assembly) having a hinge bracket being movable between a closed position and an open position; a spring assembly being configured to apply a closure force that maintains stationary positioning of the hinge bracket in the closed position, and permit movement of the hinge bracket from the closed position to the open position for a case where a user-applied force received by the hinge bracket overcomes the closure force of the spring assembly; and a separation assembly maintain separation, at least in part, between the spring assembly and the hinge bracket, and permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

In accordance with another aspect of our work, we (the inventors) have developed a method comprising maintaining separation between a spring assembly and a hinge bracket of a door assembly, the hinge bracket being movable between a closed position and an open position, the spring assembly being configured to apply a closure force that maintains stationary positioning of the hinge bracket in the closed position, and permit movement of the hinge bracket from the closed position to the open position for a case where a user-applied force received by the hinge bracket overcomes the closure force of the spring assembly; and permitting relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

In accordance with another aspect of our work, we (the inventors) have developed an apparatus comprising: a separation assembly being configured to: maintain separation, at least in part, between a spring assembly and a hinge bracket of a door assembly, the hinge bracket being movable between a closed position and an open position, the spring assembly being configured to apply a closure force that maintains stationary positioning of the hinge bracket in the closed position, and the spring assembly being configured to permit movement of the hinge bracket from the closed position to the open position for a case where a user-applied force received by the hinge bracket overcomes the closure force of the spring assembly; and permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

In accordance with another aspect of our work, we (the inventors) have developed other aspects identified in the claims.

Other aspects and features of the non-limiting embodiments may now become apparent to those skilled in the art upon review of the following detailed description of the non-limiting embodiments with the accompanying drawings.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

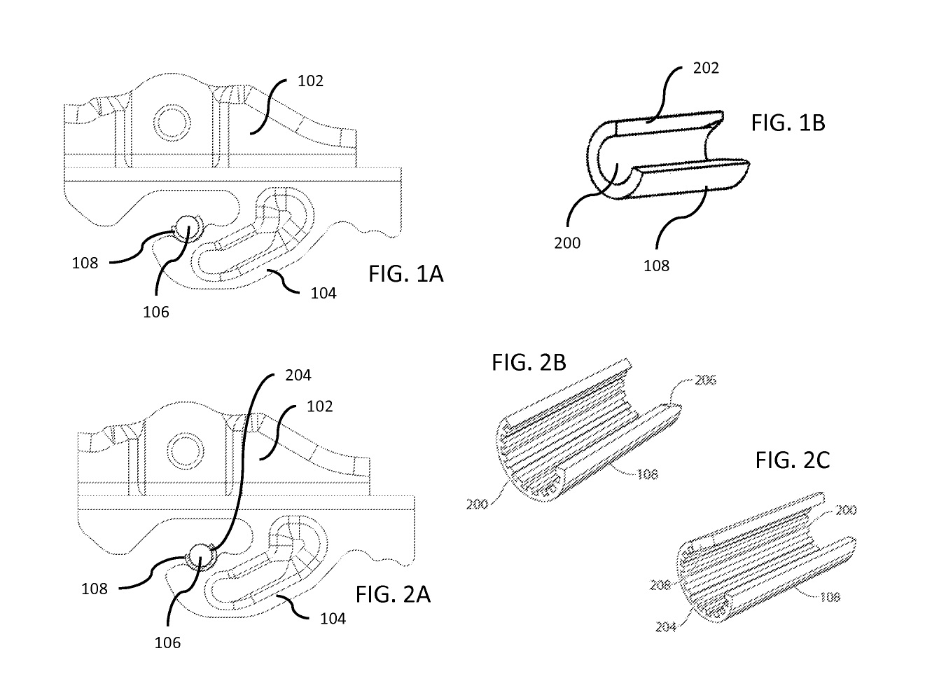

FIG. 1A depicts a side view of the apparatus;

FIG. 1B depicts a perspective view of the separation assembly of the apparatus of FIG. 1A;

FIG. 2A depicts another example of a side view the separation assembly of the apparatus;

FIGS. 2B and 2C depict example perspective views of the separation assembly of FIG. 2A;

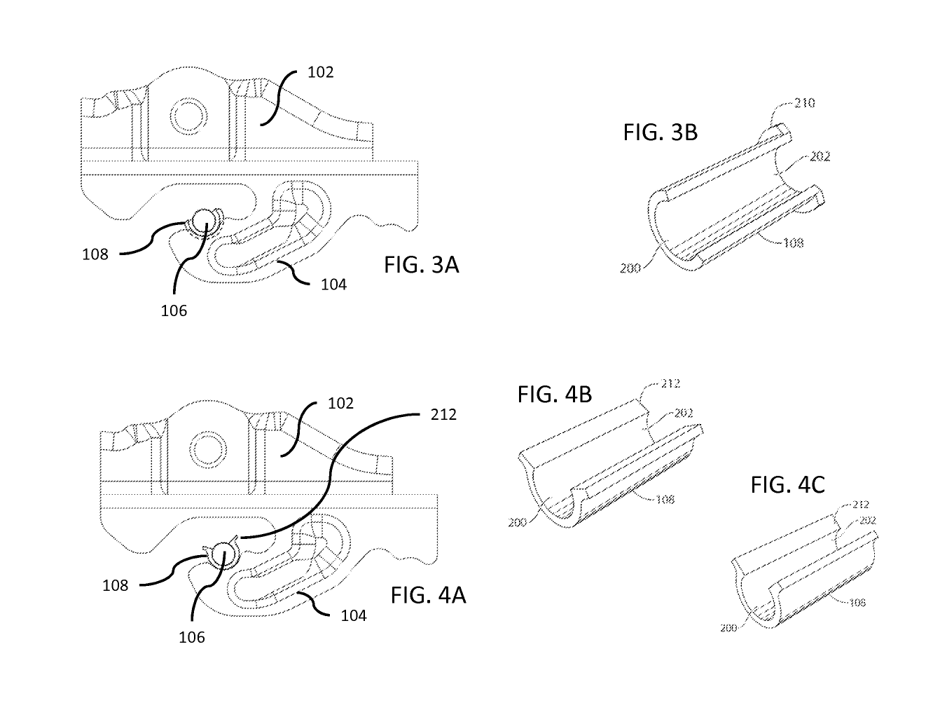

FIG. 3A depicts another example of a side view the separation assembly of the apparatus;

FIG. 3B depicts another example perspective view of the separation assembly of FIG. 3A;

FIG. 4A depicts another example of a side view the separation assembly of the apparatus;

FIGS. 4B and 4C depict other examples of perspective views of the separation assembly of FIG. 4A;

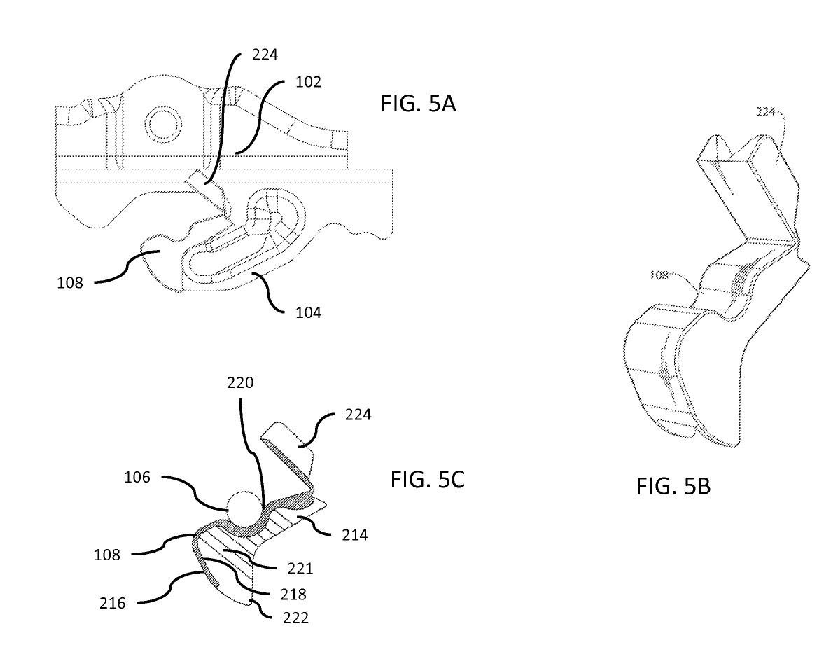

FIG. 5A depicts another example of a side view the separation assembly of the apparatus;

FIG. 5B depicts another example of a perspective view of the separation assembly of FIG. 5A;

FIG. 5C depicts an example of a cross sectional view of the separation assembly of FIG. 5A.

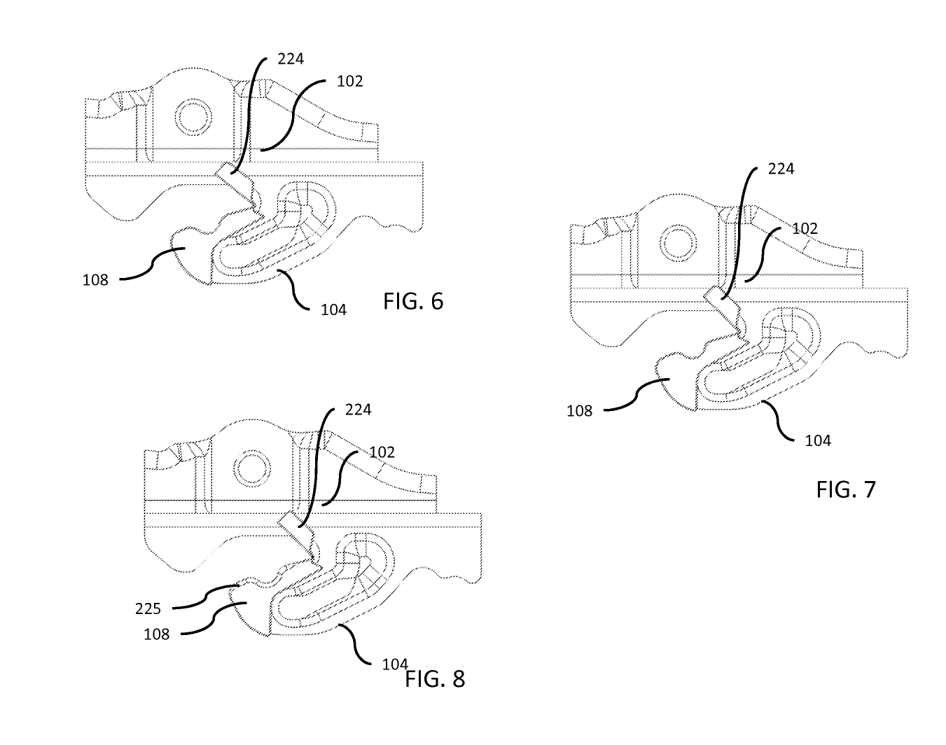

FIG. 6 depicts another example of a side view the separation assembly of the apparatus;

FIG. 7 depicts another example of a side view the separation assembly of the apparatus;

FIG. 8 depicts another example of a side view the separation assembly of the apparatus;

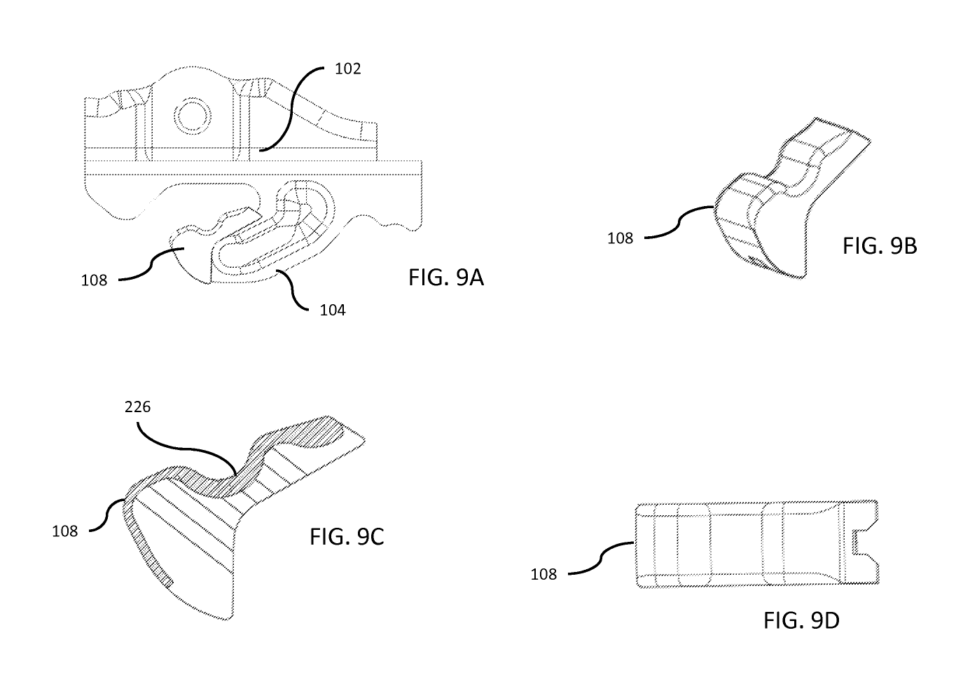

FIG. 9A depicts another example of a side view the separation assembly of the apparatus;

FIG. 9B depicts an example of an isometric view of the separation assembly of the apparatus of FIG. 9A;

FIG. 9C depicts an example of a cross sectional view of the separation assembly of the apparatus of FIG. 9A; and

FIG. 9D depicts an example of a top view of the separation assembly of the apparatus of FIG. 9A.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE EXEMPLARY EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples) aspects and/or concepts defined in the appended claims. Hence, specific dimensions and other physical characteristics relating to the embodiments disclosed herein are not to be considered as limiting, unless the claims expressly state otherwise.

Generally speaking with reference to all of the FIGS., the apparatus 100 includes (and is not limited to): (i) a door assembly 102, (ii) a spring assembly 106, and (iii) a separation assembly 108. The door assembly 102 has a hinge bracket 104 that is movable between a closed position and an open position. The spring assembly 106 is configured to apply a closure force that maintains stationary positioning of the hinge bracket 104 in the closed position. For instance, the spring assembly 106 may include a torsion spring. In addition, the spring assembly 106 is also configured to permit movement of the hinge bracket 104 from the closed position to the open position for the case where a user-applied force received by the hinge bracket 104 overcomes the closure force of the spring assembly 106. For instance, movement of the hinge bracket 104 may include lateral movement. The separation assembly 108 is configured to maintain separation, at least in part, between the spring assembly 106 and the hinge bracket 104. The separation assembly 108 is also configured to permit relative movement between the hinge bracket 104 and the spring assembly 106 without permitting the spring assembly 106 and the hinge bracket 104 from inadvertently striking (making sudden or jarring contact) against each other. In view of the above, (whereby) occurrence of unwanted noise (such as snapping sounds for example) associated with the spring assembly 106 and the hinge bracket 104 striking against each other is reduced (at least in part). For instance, striking may include catching, etc. According to a specific example, the separation assembly 108 contacts the spring assembly 106 and the hinge bracket 104 for the case where the hinge bracket 104 is placed in the closed position. Thus, the separation assembly 108 helps to avoid and/or reduce (at least in part) inadvertent striking between the spring assembly 106 and the hinge bracket 104, and so this arrangement advantageously reduces (at least in part) opportunity for inadvertently generating or creating unwanted noises. It will be appreciated that the door assembly 102, in accordance with a variation, includes a trunk assembly.

It is understood that in accordance with all of the FIGS., the spring assembly 106 moves (in use) out of the page, and the spring assembly 106 does not move along the hinge bracket 104. The movement of the spring assembly 106 occurs at the same location on the hinge bracket 104, but that the spring assembly 106 moves sideways, in effect, on the hinge bracket 104.

The spring assembly 106 is a device that is configured to store and release energy. The spring assembly 106 includes an elastic object or device used to store mechanical energy. Springs are usually made out of spring steel. Small springs can be wound from pre-hardened stock, while larger ones are made from annealed steel and hardened after fabrication. Some non-ferrous metals are also used including phosphor bronze and titanium for parts requiring corrosion resistance and beryllium copper for springs carrying electrical current (because of its low electrical resistance). When a spring is compressed or stretched, the force the spring exerts is proportional to a change in length of the spring. The rate or spring constant of a spring is the change in the force it exerts, divided by the change in deflection of the spring. An extension or compression spring has units of force divided by distance. Torsion springs have units of force multiplied by distance divided by angle. The stiffness (or rate) of springs in parallel is additive, as is the compliance of springs in series. Depending on the design and required operating environment, any material may be used to construct a spring, so long as the material has the required combination of rigidity and elasticity.

The hinge bracket 104 is a type of bearing or device that connects two objects, and is configured to allow (at least in part) rotation between the two objects. The two objects connected by the hinge rotate relative to each other about a fixed axis of rotation. The hinge may be made of flexible material or of moving components.

The door assembly 102 (or door) is a movable structure used to open and close off an entrance, typically consisting of a panel that swings on hinges or that slides or rotates inside a space. When open, the door may admit ventilation and light. The door may control the physical atmosphere within a space by enclosing the air drafts, so that interiors may be more effectively heated or cooled. Doors are significant in preventing the spread of fire. The door may also act as a barrier to noise. The door may be used to screen areas of a structure for aesthetics, keeping formal and utility areas separate, etc.

On the one hand, FIGS. 1A, 1B, 2A, 2B, 2C, 3A, 3B, 4A, 4B, 4C depict a first general approach (example or embodiment) of the separation assembly 108, in which the separation assembly 108 is coupled to the spring assembly 106.

On the other hand, FIGS. 5A, 5B, 5C, 6, 7, 8, 9A, 9B, 9C, 9D depict a second general approach (example or embodiment) of the separation assembly 108, in which the separation assembly 108 is coupled to the hinge bracket 104.

FIG. 1A depicts the side view of the apparatus 100. FIG. 1B depicts the perspective view of the separation assembly 108 of FIG. 1A. The separation assembly 108 is configured to wrap around, at least in part, the spring assembly 106. For instance, the separation assembly 108 includes a resiliently deformable body that is configured to temporarily resiliently deform during installation of the separation assembly 108 to the spring assembly 106. The separation assembly 108 may include a nylon molded bushing that physically separates the spring assembly 106 from hinge bracket 104. The separation assembly 108 (or the resiliently deformable body) has a cylindrical shape defining a central passageway 200 that extends from one end to another end of the separation assembly 108 (or of the resiliently deformable body). The separation assembly 108 (or the resiliently deformable body) has (or defines) a side-wall groove 202 extending from one end to another end of the separation assembly 108. The side-wall groove 202 is configured to receive the spring assembly 106 and permit the central passageway 200 to receive, at least in part, the spring assembly 106 (for ease of installation). The side-wall groove 202 is also configured to prevent, at least in part, accidental (unwanted) release of the spring assembly 106 from the central passageway 200.

FIG. 2A depicts another example of the side view the separation assembly 108. FIGS. 2B and 2C depict example perspective views of the separation assembly 108 of FIG. 2A. In accordance with FIG. 2A, the separation assembly 108 has or includes grooves 204 defined on an inner surface of the separation assembly 108. The grooves 204 face the spring assembly 106. The grooves 204 are configured to ease installation of the separation assembly 108 to the spring assembly 106 by reducing, at least in part, friction between the separation assembly 108 and the spring assembly 106. The grooves 204 may extend longitudinally between opposite ends of the separation assembly 108 (as depicted). According to an option (not depicted), the grooves 204 may be aligned circumferentially along the inner surface of the separation assembly 108. Referring now to FIG. 2B, the separation assembly 108 provides a feature 206 configured to ease installation of the separation assembly 108 to the spring assembly 106. For instance, the feature 206 includes a tapered-edge portion (also called a flared-end portion) defined at an end of the separation assembly 108. Referring now to FIG. 2C, the separation assembly 108 provides a feature 208 configured to ease sliding movement of the separation assembly 108 along the spring assembly 106 once the spring assembly 106 is received in the central passageway 200 of the separation assembly 108. For instance, the feature 208 includes a tapered surface (a flared-end portion) defined on an internal edge of an end of the separation assembly 108.

FIG. 3A depicts another example of the side view the separation assembly 108. FIG. 3B depicts the example perspective view of the separation assembly 108 of FIG. 3A. The separation assembly 108 includes a stop member 210 extending radially outwardly from an end portion of the separation assembly 108 relative to a longitudinal axis extending along (through) the central passageway 200 of the separation assembly 108. The stop member 210 is configured to abut an end (or side wall) of the hinge bracket 104. The stop member 210 is configured to limit, at least in part, side to side movement of the spring assembly 106. For instance, the stop member 210 may be called a flange. According to another variation (not depicted), stop members may be positioned on opposite sides of the separation assembly 108, and the stop members are configured to engage opposite corresponding walls of the hinge bracket 104.

FIG. 4A depicts another example of the side view the separation assembly 108. FIGS. 4B and 4C depict the examples of perspective views of the separation assembly 108 of FIG. 4A. The separation assembly 108 includes a wing structure 212 (extension structure) extending from opposite edges of the side-wall groove 202. The wing structure 212 may extend outwardly in a manner that facilitates manual manipulation of the separation assembly 108. Generally speaking, the wing structure 212 is configured to facilitate manual manipulation (by a user). For instance, the wing structure 212 facilitates manual manipulation (such as rotation) of the separation assembly 108 while the separation assembly 108 is installed (coupled, connected) to the spring assembly 106.

FIG. 5A depicts another example of the side view the separation assembly 108. FIG. 5B depicts the examples of the perspective view of the separation assembly 108 of FIG. 5A. FIG. 5C depicts the example of the cross sectional view of the separation assembly 108 of FIG. 5A. The separation assembly 108 defines a cavity 221 that receives, at least in part, the hinge bracket 104. The separation assembly 108 includes side walls 222 that face each other. The side walls 222 are configured to contact (or to abut) opposite sides of the hinge bracket 104. The side walls 222 act as saddle, thereby improving fit between the separation assembly 108 and the hinge bracket 104. The separation assembly 108 includes a hinged portion 224 extending from an end section of the separation assembly 108. The hinged portion 224 is configured to abut, at least in part, the door assembly 102, and the hinged portion 224 is configured to urge the separation assembly 108 to remain in contact with the hinge bracket 104, thus improving secured connection between the separation assembly 108 and the hinge bracket 104.

Referring now to FIG. 5C, there is depicted the example of the cross sectional view of the separation assembly 108, in which the separation assembly 108 includes: (i) a saddle-type configuration 214, (ii) an end cap 216, (iii) a first surface 218, and (iv) a second surface 220. The saddle-type configuration 214 is configured to (securely) engage a target surface of the hinge bracket 104 with (or against) the spring assembly 106. The end cap 216 is configured to assist location of a portion of the separation assembly 108. The first surface 218 is shaped to mimic, at least in part, the target surface region of the separation assembly 108. The second surface 220 is shaped to mimic, at least in part, a surface region of the spring assembly 106.

FIG. 6 depicts another example of a side view the separation assembly 108. The hinged portion 224 depicted in FIG. 6 is thinner than the hinged portion 224 depicted in FIG. 5A, so that this arrangement further reduces a potential for inadvertent (premature) cracking of the hinged portion 224. As well, the separation assembly 108 of FIG. 6 has a reduced surface area (not depicted) associated with the inner sides, and this arrangement facilitates ease of manual installation of the separation assembly 108 to the hinge bracket 104. As well, the hinged portion 224 includes stand-off shapes configured to abut the door assembly 102. For instance, the hinged portion 224 may be called a living hinge.

FIG. 7 depicts another example of a side view the separation assembly 108. The hinged portion 224 depicted in FIG. 7 has a raised nominal angle configured to increase stand-off force of the hinged portion 224. As well, the hinged portion 224 includes a snap-in angle that is configured to facilitate connection of the separation assembly 108 to the hinge bracket 104.

FIG. 8 depicts another example of a side view the separation assembly 108. The separation assembly 108 defines a bevelled edge 225 located along opposite sides (opposite lateral sides) of the separation assembly 108. The bevelled edge 225 is configured to reduce, at least in part, inadvertent catching (striking) of the spring assembly 106 relative to (with) the separation assembly 108.

FIG. 9A depicts another example of the side view the separation assembly 108. FIG. 9B depicts the example of the isometric view of the separation assembly 108 of the apparatus 100 of FIG. 9A. FIG. 9C depicts the example of the cross sectional view of the separation assembly 108 of the apparatus 100 of FIG. 9A. FIG. 9D depicts the example of the top view of the separation assembly 108 of the apparatus 100 of FIG. 9A. In accordance with FIGS. 9A, 9B, 9C, 9D, the separation assembly 108 does not include a hinged portion 224 associated with FIGS. 5A, 5B, 5C, 6, 7, 8. This arrangement further simplifies the construction and structure of the separation assembly 108. The separation assembly 108 fits surely to the edge of the hinge bracket 104. It may be desired that there is no relative movement of the separation assembly 108 during cycling of the door assembly 102. As well, it may be desired to avoid damage to the separation assembly 108 after a number of suitable cycles of the door assembly 102. The number of cycles of the door assembly 102 may be representative of usage over life of a vehicle. It may be desired that the separation assembly 108 not move or become damaged under hot conditions and/or cold conditions associated with the application, such as 1200 cycles at −30 degrees Centigrade (−22 degrees Fahrenheit) and 1200 cycles at 80 degrees Centigrade (176 degrees Fahrenheit). A consideration is to configure the separation assembly 108 to handle torque (force) associated with spring assembly 106 over the desired design life of the apparatus 100. The separation assembly 108 fits securely over a leading edge of the hinge bracket 104 of the door assembly 102. The separation assembly 108 provides an amount of material, such as 1.5 millimetres (0.05906 inches) of material, between the hinge bracket 104 and spring assembly 106. The separation assembly 108 may include a smooth self-lubricating surface on which the spring assembly 106 sits and moves without inadvertent catching the separation assembly 108. A concave-mating feature 226 located on the separation assembly 108 secures (cradles) the spring assembly 106 axially while allowing the spring assembly 106 to move laterally. The separation assembly 108 may include lead-in shapes and internal features configured to ease installation of the separation assembly 108. The front edge of the separation assembly 108 is extended to allow a larger area that facilitates ease of handling and installation of the separation assembly 108. It may be desired that the separation assembly 108 withstand expected thermal and mechanical stress levels. Several types of materials (plastic) may be used in the separation assembly 108. For example, the separation assembly 108 may include a body having approximately 80% DUPONT (TRADEMARK) ZYTEL (TRADEMARK) with an overall glass content of approximately 6%. It may be desired that a material used in the separation assembly 108 provide a compromise of hardness, self-lubrication and thermal resistance.

The apparatus 100 address the problem of noise caused by shifting of the spring assembly 106 along the hinge bracket 104. The hinge bracket 104 may be used or installed in a trunk, a car or (in general) a vehicle. The relative shifting (movement) between the spring assembly 106 and the hinge bracket 104 may cause unwanted (inadvertent) snapping sounds or striking noises as a result of the hinge bracket 104 and the spring assembly 106 inadvertently striking against each other if it were not for the separation assembly 108 preventing the inadvertent striking The problem is resolved, at least in part, with the separation assembly 108 installed relative to the spring assembly 106 and the hinge bracket 104. In accordance with an example, the separation assembly 108 provides a reduced friction (or self-lubrication) seating surface for the spring assembly 106. In accordance with one option, the separation assembly 108 has the configuration of a saddle configured to engage the hinge bracket 104 at the target surface region that would contact the spring assembly 106 if it were not for the separation assembly 108. The separation assembly 108 has an end cap 216 that assists in locating the separation assembly 108 in place and an upper surface which is shaped to mimic the target surface region.

The apparatus 100 may be applied anywhere where there is an interface between the spring assembly 106 and the hinge bracket 104 where is relative movement between the spring assembly 106 and the hinge bracket 104. A relative movement between the spring assembly 106 and the hinge bracket 104 may lead to unwanted striking between the spring assembly 106 and the hinge bracket 104 that may raise the potential of an undesirable noise.

For the case where the separation assembly 108 includes a C-shaped cross section, and the C-shaped cross section has an opening such that the opening appears at the interface between the spring assembly 106 and the hinge bracket 104, there may be a potential for unwanted noise. This case may occur because there is a possibility of installation error and/or migration of the separation assembly 108 due to wear or heat over time. If this is the case, then the other examples of the separation assembly 108 may be used.

Other examples of the separation assembly 108 may mitigate (offset) the effects of heat over time that has the effect of deforming the cross section of the separation assembly 108. However, if the opening of the C section of the separation assembly 108 cannot be tolerated, then another variant or example of the separation assembly 108 may be considered so as to completely eliminate the risk of the open section of the separation assembly 108, the so called C section, being positioned at the spring-bracket interface.

In accordance with the examples that include the hinged portion 224 (the live hinge-connected upstanding portion). The hinged portion 224 is configured to hold and maintain, at least in part, the separation assembly 108 against the hinge bracket 104. On the other hand, the separation assembly 108 does not have to include the hinged portion 224.

According to some examples, the separation assembly 108 fits securely over a leading edge of the hinge bracket 104, thus creating a smooth, self-lubricated surface on which the spring assembly 106 sits and moves laterally without catching.

Generally, the aspects or examples are concerned with springs and supports, and more specifically for torsion springs installed in a trunk of a vehicle.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. An apparatus comprising:
a hinge bracket;
a spring assembly configured to operatively interact with the hinge bracket; and
a separation assembly being configured to permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

2. An apparatus comprising:
a door assembly having a hinge bracket being movable between a closed position and an open position;
a spring assembly being configured to apply a closure force that maintains stationary positioning of the hinge bracket in the closed position, and permit movement of the hinge bracket from the closed position to the open position for a case where a user-applied force received by the hinge bracket overcomes the closure force of the spring assembly; and
a separation assembly being configured to:
maintain separation, at least in part, between the spring assembly and the hinge bracket, and
permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

3. The apparatus of claim 2, wherein:
the separation assembly is configured to contact the spring assembly and to contact the hinge bracket for the case where the hinge bracket is placed in the closed position.

4. The apparatus of claim 2, wherein:
the separation assembly is coupled to the spring assembly.

5. The apparatus of claim 2, wherein:
the separation assembly is configured to wrap around, at least in part, the spring assembly.

6. The apparatus of claim 2, wherein:
the separation assembly includes:
a resiliently deformable body that is temporarily deforms during installation of the separation assembly to the spring assembly.

7. The apparatus of claim 2, wherein:
the separation assembly has a cylindrical shape defining a central passageway that extends from one end to another end of the separation assembly.

8. The apparatus of claim 2, wherein:
the separation assembly defines a side-wall groove extending from one end to another end of the separation assembly, and the side-wall groove is configured to:
receive the spring assembly into a central passageway of the separation assembly, and
prevent accidental release of the spring assembly from the central passageway.

9. The apparatus of claim 2, wherein:
the separation assembly includes:
grooves being defined on an inner surface of the separation assembly, the grooves facing the spring assembly, and the grooves being configured to ease installation of the separation assembly to the spring assembly by reducing friction between the separation assembly and the spring assembly.

10. The apparatus of claim 2, wherein:
the separation assembly provides a feature configured to ease installation of the separation assembly to the spring assembly.

11. The apparatus of claim 2, wherein:
the separation assembly provides a feature configured to ease sliding movement of the separation assembly along the spring assembly once the spring assembly is received in a central passageway of the separation assembly.

12. The apparatus of claim 2, wherein:
the separation assembly includes:
a stop member extending radially outwardly from an end portion of the separation assembly relative to a longitudinal axis extending along a central passageway, and the stop member is configured to abut an end of the hinge bracket, and thus limits, at least in part, side to side movement of the spring assembly.

13. The apparatus of claim 2, wherein:
the separation assembly includes:
a wing structure extending from opposite edges of a side-wall groove, and the wing structure is configured to facilitate manual manipulation.

14. The apparatus of claim 2, wherein:
the separation assembly is coupled to the hinge bracket.

15. The apparatus of claim 2, wherein:
the separation assembly defines a cavity that receives the hinge bracket.

16. The apparatus of claim 2, wherein:
the separation assembly includes:
side walls that face each other, and the side walls are configured to contact opposite sides of the hinge bracket.

17. The apparatus of claim 2, wherein:
the separation assembly includes:
a hinged portion extending from an end section of the separation assembly, and the hinged portion is configured to abut, at least in part, the door assembly, and the hinged portion is configured to urge the separation assembly to remain in contact with the hinge bracket, thus improving secured connection between the separation assembly and the hinge bracket.

18. The apparatus of claim 2, wherein:
the separation assembly includes:
a saddle-type configuration being configured to securably engage a target surface of the hinge bracket with the spring assembly;
an end cap configured to assist location of a portion of the separation assembly;
a first surface being shaped to mimic, at least in part, a target surface region of the separation assembly; and
a second surface being shaped to mimic, at least in part, a surface region of the spring assembly.

19. The apparatus of claim 2, wherein:
the separation assembly includes:
a hinged portion has a raised nominal angle configured to increase stand-off force of the hinged portion, and the hinged portion includes:
a snap-in angle being configured to facilitate connection of the separation assembly to the hinge bracket.

20. The apparatus of claim 2, wherein:
the separation assembly defines a bevelled edge located along opposite sides of the separation assembly to further reduce possibility of inadvertent catching of the spring assembly with the separation assembly.

21. The apparatus of claim 2, wherein:
a concave-mating feature located on the separation assembly secures the spring assembly axially while allowing the spring assembly to move laterally.

22. The apparatus of claim 2, wherein:
the separation assembly includes:
a smooth self-lubricating surface on which the spring assembly sits and moves without inadvertently catching the separation assembly.

23. The apparatus of claim 2, wherein:
the door assembly includes a trunk assembly.

24. An apparatus comprising:
a separation assembly being configured to permit relative movement between a hinge bracket and a spring assembly configured to operatively interact with the hinge bracket without permitting the spring assembly and the hinge bracket from inadvertently striking against each other, whereby occurrence of unwanted noise associated with the spring assembly and the hinge bracket striking each other is reduced.

25. An apparatus comprising:
a separation assembly being configured to:
maintain separation, at least in part, between a spring assembly and a hinge bracket of a door assembly, the hinge bracket being movable between a closed position and an open position, the spring assembly being configured to apply a closure force that maintains stationary positioning of the hinge bracket in the closed position, and the spring assembly being configured to permit movement of the hinge bracket from the closed position to the open position for a case where a user-applied force received by the hinge bracket overcomes the closure force of the spring assembly; and
permit relative movement between the hinge bracket and the spring assembly without permitting the spring assembly and the hinge bracket from inadvertently striking against each other, whereby occurrence of unwanted noise associated with the spring assembly and the hinge bracket striking each other is reduced.

26. A method comprising:
maintaining separation between a spring assembly and a hinge bracket of a door assembly, the hinge bracket being movable between a closed position and an open position, the spring assembly being configured to apply a closure force that maintains stationary positioning of the hinge bracket in the closed position, and permit movement of the hinge bracket from the closed position to the open position for a case where a user-applied force received by the hinge bracket overcomes the closure force of the spring assembly; and
permitting relative movement between the hinge bracket and the spring assembly without permitting the spring assembly and the hinge bracket from inadvertently striking against each other, whereby occurrence of unwanted noise associated with the spring assembly and the hinge bracket striking each other is reduced.
